(19) United States
(12) Patent Application Publication
(10) Pub. No.: US 2024/0269898 A1
(43) Pub. Date: Aug. 15, 2024

(54) TIE-BAR-LESS CLAMPING UNIT

(71) Applicant: ENGEL AUSTRIA GmbH, Schwertberg (AT)

(72) Inventors: Lukas Muttenthaler, Schwertberg (AT); Gerhard HACKL-LEHNER, St. Thomas/ Bl. (AT); Christoph BALKA-HINTERSTEINER, Schwertberg (AT); Friedrich PERNKOPF, Gramastetten (AT); Stephan EPPICH, Arbing (AT); Johannes MAYR, Ennsdorf (AT); Anton LOHNECKER, Ertl (AT); Markus OTTO, Ernsthofen (AT); Florian MESSNER, Linz (AT); Lukas GUGLER, St. Peter/Au (AT); Klaus Hubert GATTRINGER, Tragwein (AT); Stephan BAUERNFEIND, Ried in der Riedmark (AT); Reinhard GRATZL, Lasberg (AT); Herwig KOPPAUER, Linz (AT)

(21) Appl. No.: 18/435,373

(22) Filed: Feb. 7, 2024

(30) Foreign Application Priority Data
Feb. 9, 2023 (AT) A 50082/2023

(51) Int. Cl. B29C 33/20; B29C 33/24; B29C 33/44

(52) U.S. Cl. CPC B29C 33/202; B29C 33/24; B29C 33/442

(57) ABSTRACT

A tie-bar-less clamping unit for a moulding machine includes a machine frame formed for absorbing clamping forces, and a fixed platen arranged stationary in relation to the machine frame. A movable platen can move relative to the machine frame, and at least one push rod is preferably arranged substantially centrally with respect to the movable platen. At least one pressure pad is arranged between the push rod and the movable platen.

The present application claims priority to Austrian Patent Application No. A 50082/2023, filed Feb. 9, 2023. Thus, all of the subject matter of Austrian Application No. A 50082/2023 is incorporated herein by reference.

### BACKGROUND OF THE INVENTION

The present invention relates to a tie-bar-less clamping unit, as well as a moulding machine with such a clamping unit.

By moulding machines can be meant injection moulding machines, transfer moulding machines, presses and the like. Moulding machines in which the plasticized material is supplied to an open mould are also entirely conceivable.

In many types of clamping units, the procedure consists of a fast stroke and a power stroke.

The fast stroke is used for the rapid movement of the movable platen, for example mould platen, in order to be able to carry out a closing and/or opening movement of the clamping unit.

The power stroke is used for the application of the clamping force in a very slight movement and is therefore substantially to be understood to be the application of a large force and not necessarily literally as a movement.

Tie-bar-less or columnless clamping units have a machine frame, which is formed for absorbing clamping forces. This machine frame is often formed C-shaped.

During the application of the clamping force, the large clamping force results in the problem that the machine frame deforms, wherein C-shaped machine frames usually open out.

The opening-out of the machine frame can cause an undesired tilting of the fixed platen and/or the movable platen and/or the ejector support plate, if present. The tilting of these platens will henceforth be called platen tilting.

The platen tilting can lead to problems in the clamping process, in particular during the application of the clamping force.

For example, jamming or the like can occur, which can result in increased wear of the individual component parts.

Furthermore, it can be the case that, due to the platen tilting, the desired parallelism of the fixed platen and the movable platen no longer exists, which can in turn lead to an uneven application of the clamping force and/or pressure distribution on the mould. The parallelism between the fixed platen and the movable platen will henceforth be called platen parallelism.

The platen tilting and/or the uneven application of the clamping force can, for example, lead to disruptions in the production procedure, efficiency losses, losses of quality etc.

Devices for compensating for platen tilting, which improve at least the alignment of the fixed platen and/or the movable platen and/or the platen parallelism, for example by means of one or more (flexure) hinges, wherein the latter are arranged on the machine frame and/or on the fixed platen and/or the movable platen and/or the ejector support plate, are known from the state of the art, e.g. from patent documents DE 4313472 A1, EP 0311133 B1 and EP 0554068 A1.

In other words, the opening-out of the machine frame during the application of the clamping force is at least partially compensated for through the arrangement of (flexure) hinges, with the result that the platen parallelism, in particular the parallelism between the fixed platen and the movable platen, is substantially preserved.

A disadvantage of this can be that further guide elements have to be arranged along the machine frame such that, during the clamping procedure and/or the building-up of the clamping force, the fixed platen and/or the movable platen align or tilt themselves in each case individually such that they are aligned parallel to each other.

In the case of tie-bar-less clamping units, hydraulic cylinder drive mechanisms, e.g. plunger cylinders, which hold a large fluid volume, are often used for the power stroke.

Due to the opening-out of the machine frame and because of the large fluid volume of at least one hydraulic cylinder drive mechanism, the problem exists that a very large fluid volume has to be mobilized and compressed to overcome the opening-out, as a result of which it takes a very long time for the clamping force to build up until the clamping force is reached.

Furthermore, the mobilization and compression of the large fluid volume of the hydraulic cylinder drive mechanism require a large energy input, which has a very disadvantageous effect on the energy efficiency of the clamping unit.

### SUMMARY OF THE INVENTION

The object of the present invention is now to provide a clamping unit that is improved compared with the state of the art and which further improves the preservation of the platen parallelism and at the same time shortens the duration of the building-up of the clamping force and/or reduces the required energy input.

This object is achieved by a tie-bar-less clamping unit for a moulding machine, comprising:
a machine frame, which is formed for absorbing clamping forces, and
a fixed platen arranged stationary in relation to the machine frame, and
a movable platen that can move relative to the machine frame, and
at least one push rod, preferably arranged substantially centrally with respect to the movable platen,
   wherein at least one pressure pad is arranged between the push rod and the movable platen.

Protection is also sought for a moulding machine, in particular comprising a substantially C-shaped machine frame, with a clamping unit according to the invention.

By a pressure pad is meant, in particular, a hydraulic cylinder with a relatively short stroke, which is formed or designed for the application of a large force.

In general, hydraulic cylinders comprise a fluid volume, a piston rod and a piston head.

In the case of pressure pads, the fluid volume is usually relatively small due to the short piston rod and the short stroke, which is why a rapid mobilization and/or compression of the fluid volume is possible.

In the case of the clamping unit according to the invention, this makes it possible to apply the clamping force rapidly and/or to overcome the opening-out of the frame.

The use of at least one pressure pad also advantageously involves a smaller energy input, in particular in comparison with a plunger cylinder with a large fluid volume.

The name pressure pad is predominantly used to differentiate from hydraulic cylinders with a relatively large fluid volume, such as e.g. plunger cylinders and/or fast stroke cylinders.

The major advantage of the invention is that during the application of the clamping force the platen tilting is simultaneously counteracted and/or platen parallelism is achieved, wherein in particular the tilting of the movable platen is compensated for.

This compensation is possible in particular due to a targeted and/or precise actuation of the at least one pressure pad.

However, it can also be the case that, in the case of a tilted fixed or movable platen, the fixed or movable platen is aligned by the at least one pressure pad such that the platen parallelism is produced and/or maintained.

In any case, this means that the achievement of the parallelism of the fixed platen and the movable platen is greatly simplified compared with the state of the art.

In general, one or more pressure pads can be arranged between the at least one push rod and the movable platen.

Through the actuation of individual pressure pads, a targeted application of pressure to the movable platen and/or the fixed platen is possible.

The preservation and/or improvement of the platen parallelism makes an optimum application of the clamping force and pressure distribution on the mould possible.

The clamping unit according to the invention furthermore has the advantages compared with the state of the art that it:
makes a lower-loss operation, e.g. with lower frictional losses, possible and/or
makes a more efficient operation possible, e.g. due to the smaller fluid volume to be mobilized and to be compressed and/or smaller frictional losses, and/or
has a smaller space requirement in the longitudinal direction of the machine, e.g. since pressure pads have smaller dimensions, and/or
makes a reduced cycle time possible, e.g. due to the smaller fluid volume in the pressure pads.

Preferably, the clamping unit has a movable ejector support plate, which can move and is arranged between the at least one push rod and the movable platen.

Preferably, at least one pressure pad is arranged between the at least one push rod and the ejector support plate, if the ejector support plate is present.

At least one pressure pad can be arranged between the ejector support plate, if present, and the movable platen.

It is also possible that the clamping unit does not comprise an ejector support plate.

It is preferable that the clamping unit has a force transmission unit which is arranged between the push rod and the movable platen, with the result that the force from the push rod is transmitted as far as the movable platen by means of the force transmission unit.

The force transmission unit can consist of various components which, as a whole, achieve an advantageous effect with respect to the platen parallelism and/or the application of the clamping force.

The force transmission unit is preferably formed such that at least one part and/or element of the force transmission unit deforms and/or tilts during the application of the clamping force, with the result that there is a beneficial effect on the platen parallelism and/or the latter is achieved and/or is preserved.

Furthermore, the force transmission unit is preferably formed such that the fast stroke movement and/or the power stroke and/or the application of the clamping force is optimizable. In other words, for example, the force transmission unit is designed such that frictional losses can be kept low and/or the cycle times can be kept short and/or the application of the clamping force can be effected evenly.

Preferably, the force transmission unit comprises at least one piston rod and/or at least one rod and/or at least one flexure hinge.

Components of the force transmission unit are, for example, (flexure) hinges such as e.g. Flex Link and/or Force Divider elements, (flexure) springs, rods, which are formed such that they are loadable by tension and/or compression and/or bending and/or torsion, depending on the defined mode of operation.

The rigidity or flexibility of a force transmission unit is adaptable, for example, by means of the lengths, cross sections, geometries, material properties etc. of the subcomponents, such as the rods and/or the (flexure) hinges.

In the case of a clamping unit according to the invention with the at least one pressure pad, such a force transmission unit can be understood to be a hydraulically activated force transmission unit with a platen tilt compensation action.

It is also possible to exert influence on the distribution of the clamping force by tilting the piston rod of the at least one pressure pad.

Furthermore, by tilting the piston rod of the at least one pressure pad, influence can be exerted on the force transmission unit, which in turn influences the distribution of the clamping force.

The ejector support plate can act as a supporting plate for the at least one force transmission unit and/or the at least one pressure pad.

Possible variants of the arrangement of the at least one pressure pad in the longitudinal direction of the machine, in particular in combination with at least one force transmission unit and/or ejector support plate, are, for example, the arrangement of at least one pressure pad
before and/or after an ejector support plate and/or
before and/or after a force transmission unit and/or
before the movable platen.

It is generally also conceivable that the at least one pressure pad is arranged behind the fixed platen, for example between the fixed platen and the machine frame.

Possible variants of the arrangement of the at least one pressure pad in relation to the movable platen are, for example, the arrangement of:
a central pressure pad, and/or
two pressure pads, arranged in each case in one half of the movable platen, which lie on a horizontal and/or vertical connecting line, and/or
four pressure pads arranged as a rectangle, wherein the rectangle can be turned by an angle, in particular by an angle of 45°.

The pressure pads preferably have circular or annular pressure profiles.

Also, the fixed platen and/or the movable platen and/or at least one mould platen can be mounted in a fluid bed.

The mounting of the fixed platen and/or the movable platen and/or at least one mould platen in a fluid bed beneficially serves to prevent and/or to compensate for the platen tilting and/or in order to achieve and/or to preserve platen parallelism.

By a fluid bed is meant a mounting in the form of a bowl-shaped recess in the fixed platen or movable platen, wherein the fluid bed extends over the majority of a lateral surface of the fixed platen or movable platen and encloses a mould platen roughly on one side.

In other words, the application of the clamping force to the mould is preferably effected not directly via the fixed and/or movable platen but via at least one mould platen mounted in the fixed and/or movable platen.

The fluid bed preferably comprises a seal between the edge of the recess in the fixed or movable platen and the mould platen, and a fluid, which is located in the space between the bowl-shaped recess in the fixed and/or movable platen and the mould platen.

A fluid bed beneficially brings about an even hydrostatic pressure distribution on the fixed platen and/or movable platen and the at least one mould platen mounted therein.

The fluid or the properties of the fluid, such as e.g. the viscosity, can be adapted and/or optimized according to the requirements.

The fluid can be, for example, water, hydraulic oil or another liquid.

Preferably, if a mould platen is mounted in a fluid bed, the movement of the fixed platen and/or the movable platen and/or the mould platen is guided and/or they are mounted at selected points, with the result that an involuntary and/or unwanted tilting of the fixed platen and/or the movable platen and/or the mould platen cannot occur.

Preferably, the fluid bed and the fixed platen and/or the movable platen and/or the at least one mould platen are designed, in particular by a protrusion on the mould platen, such that together they have the function of an in particular double-acting hydraulic cylinder.

Thus, the mould platen and the fixed platen and/or the mould platen and the movable platen can in combination in each case be regarded as a type of hydraulic cylinder.

Here, the mould platen can be envisaged as a type of piston rod, if it is formed like this, and the fixed platen and/or the movable platen with the recess of the fluid bed can be envisaged as a cylinder tube, and the fluid of the fluid bed as a hydraulic fluid.

It is also conceivable that a fluid bed is used as an alternative to a pressure pad. In other words, a fluid bed can take on the function of a pressure pad, i.e. replace it.

This means both that the fixed platen and/or the movable platen can be actuated in each case with at least one pressure pad and that they can be mounted in each case in a fluid bed.

It is also possible that the at least one pressure pad and/or at least one fluid bed can be arranged in each case between the push rod and the fixed platen and/or the machine frame.

However, other devices are also conceivable, which guide the fixed platen and/or the movable platen and/or the at least one mould platen such that the platen parallelism is preserved or improved as much as possible.

It is preferable that the clamping unit has at least one fast stroke drive mechanism for carrying out a fast stroke movement.

Fast stroke drive mechanisms can be e.g. electromechanical or hydraulic drive mechanisms, wherein hydraulic drive mechanisms have fast stroke cylinders.

Preferably, the clamping unit comprises a measuring unit for capturing data, wherein the measuring unit is formed at least to capture data relating to the application of the clamping force and/or the parallelism of the fixed platen and the movable platen.

Data relating to the platen parallelism are, for example, an angle of inclination of the fixed platen and/or the movable platen and/or a relative angle between the fixed platen and the movable platen.

Data relating to the application of the clamping force are, for example, pressure distributions and/or compressive and/or tensile forces in particular positions on particular component parts of the clamping unit and/or adjacent component parts, e.g. on the mould.

Data captured by the measuring unit can also be data relating to the surroundings, such as e.g. temperature, air humidity, etc., and/or relating to the clamping unit, such as e.g. stretching and/or deformations of particular component parts of the clamping unit and/or adjacent component parts.

The captured data can be used directly and/or for deriving further data.

Preferably, the clamping unit comprises a control or regulation unit for controlling or regulating the clamping unit, in particular the at least one pressure pad, preferably on the basis of data relating to the application of the clamping force and/or the parallelism of the fixed platen and the movable platen.

A control unit is preferably to be understood as a control unit performing open-loop control.

Controlling preferably means an application of open-loop control.

A regulation unit is preferably to be understood as a control unit performing closed-loop control.

Regulating preferably means an application of closed-loop control.

It is preferable that the at least one pressure pad is at least two pressure pads, and the control or regulation unit is formed to control or to regulate a first and a second of the at least two pressure pads depending on each other, and preferably also independently of each other.

In the case of advantageous embodiments with more than one pressure pad between the push rod and the movable platen and/or the fixed platen, it is particularly preferable that the at least two pressure pads are individually controllable or regulatable.

An individual control or regulation means that it is possible to control or to regulate the application of force by each individual pressure pad separately with respect to the duration of the building-up of the force and/or the duration of the application of the force and/or the magnitude of the relative and/or absolute force and/or the times at which the application of the force starts and ends.

The control or regulation of several pressure pads can be effected separately and/or coupled and/or synchronously and/or asynchronously.

A separate control or regulation means that the function of one pressure pad does not influence the function of at least one second pressure pad, whereas in the case of a coupled control or regulation the functions of the pressure pads influence each other.

In other words, this means that several pressure pads can be controlled or regulated without dependence or in dependence on each other.

By a synchronous control or regulation of several pressure pads is meant that the start times and the end times of the building-up of the clamping force and/or the application of the clamping force by the individual pressure pads are identical, whereas in the case of an asynchronous control or regulation at least some of those times differ between the individual pressure pads.

The control or regulation can be preset and/or effected by live feedback.

For this, a wide variety of process models and/or optimization methods, for example through the application of intelligent algorithms, or the like can be used.

At least one locking device which locks the drive mechanism, in particular for the application of the clamping force, is preferably located at the end of the push rod, such as for example at the end opposite the at least one pressure pad.

Preferably, the clamping unit according to the invention is used with a fast stroke drive mechanism, preferably with a fast stroke cylinder.

The locking device is preferably designed decoupled from the at least one pressure pad and/or from the at least one fast stroke drive mechanism.

The pressure pad beneficially moves substantially together with the movable platen and/or the ejector support plate, i.e. it is thus not a component part arranged statically on the machine frame.

However, it is also conceivable to use the invention with a drive mechanism with a mechanical clamping mechanism, such as e.g. a toggle mechanism, or another clamping mechanism.

### BRIEF DESCRIPTION OF THE DRAWINGS

Further advantages and details of the invention are revealed by the figures and the associated description of the figures, in which:

FIG. 1 shows a first embodiment of a clamping unit according to the invention,

FIG. 2 shows a second embodiment of a clamping unit according to the invention,

FIG. 3 shows a third embodiment of a clamping unit according to the invention,

FIG. 4 shows examples of possible arrangements of pressure pads on a platen,

FIGS. 5a-b show a fourth embodiment of a clamping unit according to the invention,

FIG. 6 shows two embodiments of a fluid mounting of a platen,

FIG. 7 shows a moulding machine with a clamping unit and

FIG. 8 shows a fifth embodiment of a clamping unit according to the invention.

### DETAILED DESCRIPTION OF THE INVENTION

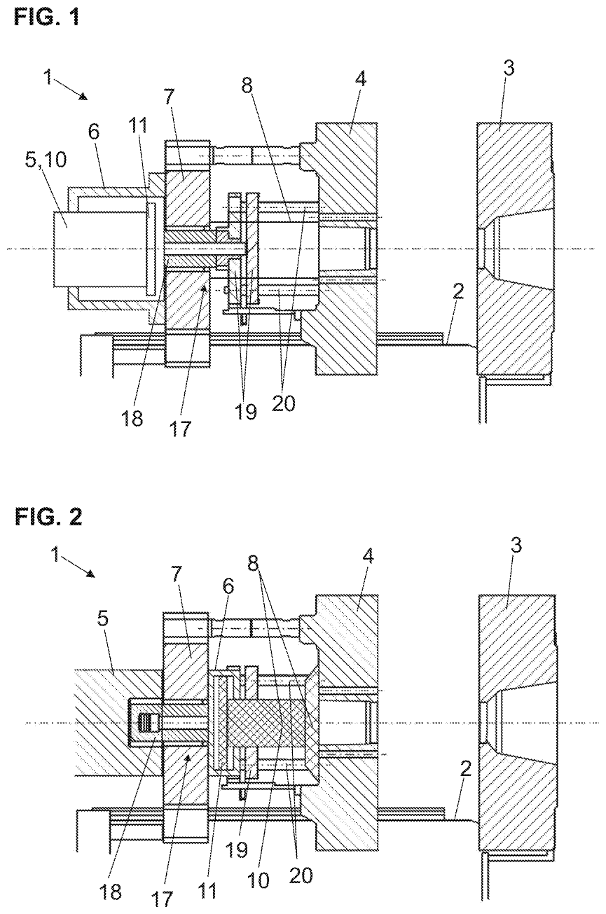

FIG. 1 shows a section through a first embodiment of a tie-bar-less clamping unit 1 according to the invention for a moulding machine 16, comprising
a machine frame 2, which is formed for absorbing clamping forces, and
a fixed platen 3 arranged stationary in relation to the machine frame 2, and
a movable platen 4 that can move relative to the machine frame 2, and
at least one push rod 5, preferably arranged substantially centrally with respect to the movable platen 4,
   wherein at least one pressure pad 6 is arranged between the push rod 5 and the movable platen 4.

In this embodiment, the end of the push rod 5 facing the movable platen 4 is arranged adjacent to the piston rod 10 of the at least one pressure pad 6.

It is preferably to be understood that the left end of the push rod 5 extends further to the left of FIG. 1 (away from the movable platen 4) and that the pressure pad 6, in particular the piston rod 10, is arranged at the right end of the push rod 5 in FIG. 1.

Preferably, exactly one pressure pad 6 is arranged substantially centrally with respect to the movable platen 4.

This embodiment has a movable ejector support plate 7 that can move between the at least one push rod 5 and the movable platen 4, wherein at least one pressure pad 6 is arranged between the ejector support plate 7 and the push rod 5.

As is preferable, FIG. 1 shows at least one force transmission unit 8 arranged between the at least one push rod 5 and the movable platen 4.

The force transmission unit 8 particularly preferably comprises at least one piston rod 10 and/or one rod and/or one flexure hinge.

The force transmission unit 8 can generally comprise a combination of a wide variety of force-transmitting elements with a wide variety of arrangements in relation to each other and in relation to other component parts of the clamping unit.

In the case of this first embodiment the introduction of force is thus effected through the pressure pad 6 directly into the ejector support plate 7, from where it is transferred to the movable platen 4 by means of the force transmission unit 8.

A locking unit can be located at the end of the push rod 5 opposite the movable platen 4.

In addition, an ejector device 17, which comprises an ejector bolt 18, ejector plates 19 and ejectors 20 and is used to eject a moulded part, is shown in FIG. 1.

In this and all following embodiments, the at least one pressure pad 6 is located in the movable part of the clamping unit 1.

To avoid repetition, it is primarily the differences from the first embodiment that are discussed in the following description of further embodiments. Otherwise, the above description of the first embodiment also holds, where applicable, for the embodiments still to be described below.

FIG. 2 shows a section through a second embodiment of a clamping unit 1 according to the invention.

This embodiment has a movable ejector support plate 7 that can move between the at least one push rod 5 and the movable platen 4, wherein at least one pressure pad 6 is arranged between the ejector support plate 7 and the movable platen 4.

Here, for a preferably symmetrical application of the clamping force, two pressure pads 6 are preferably arranged on the ejector support plate 7, in particular substantially on both sides of the force transmission unit 8.

However, several pressure pads 6 can also be arranged between the ejector support plate 7 and the movable platen 4, beneficially with at least single symmetry.

This embodiment also comprises an ejector device 17, wherein the whole ejector bolt 18 is shown in this figure.

The relatively long at least one piston rod 10 of the at least one pressure pad 6 of this embodiment can be understood to be a subcomponent of the force transmission unit 8.

A type of force distribution plate is beneficially located at the end of the piston rod 10 facing the movable platen 4 as a further subcomponent of the force transmission unit 8.

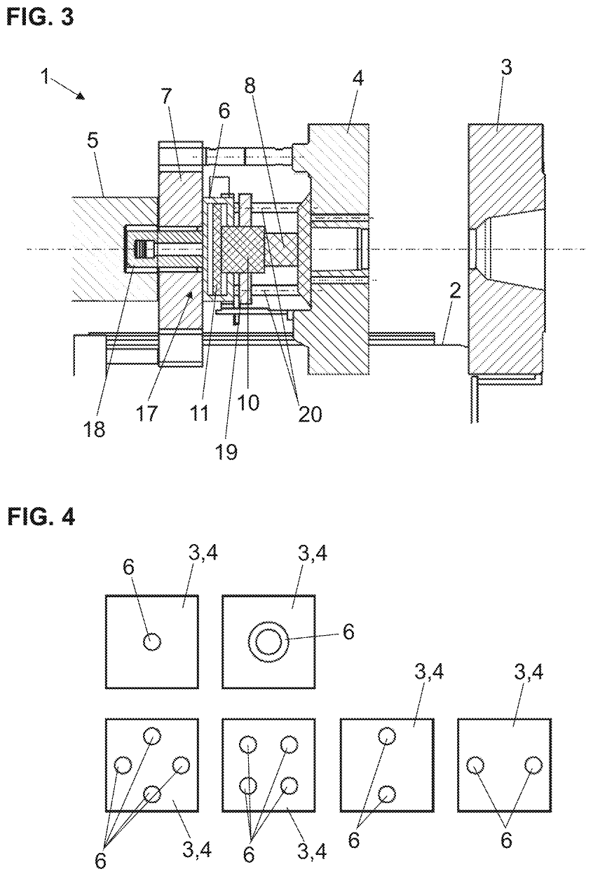

FIG. 3 shows a section through a third embodiment of a clamping unit 1 according to the invention, which is largely the same as the second embodiment of FIG. 2.

This embodiment differs from the second embodiment in that the piston rod 10 of the at least one pressure pad 6 is designed shorter and a further rod is arranged following the piston rod 10.

This further rod can be regarded as a subcomponent of the force transmission unit 8.

With such a combination of piston rod 10 and rod or force transmission element it is possible, for example, to adapt the rigidities and/or the deformation behaviour of the force transmission unit 8 and consequently to exert influence on the tilting behaviour of the movable platen 4.

FIG. 4 shows six views of examples of possible and preferred arrangements of pressure pads 6 on a fixed platen 3 and/or movable platen 4.

As can be seen in FIG. 4, it is particularly preferable that the at least one pressure pad 6 is arranged substantially symmetrically, preferably with double symmetry, on the platen, with the result that as symmetrical an application of the clamping force as possible is achieved.

The at least one pressure pad 6 preferably has a circular or annular shape. However, other shapes, e.g. rectangular shapes, are also possible.

The first example at the top left in FIG. 4, which has a centrally arranged pressure pad 6, can correspond to the first embodiment, shown in FIG. 1, for example.

The last example at the bottom right in FIG. 4, which has two symmetrically arranged pressure pads 6, can correspond to the second embodiment, shown in FIG. 2, and/or the third embodiment, shown in FIG. 3.

Through individual actuation of the pressure pads 6, a different, preferably optimized, introduction of force is possible, whereby the platen parallelism and/or the distribution of the clamping force can be regulated.

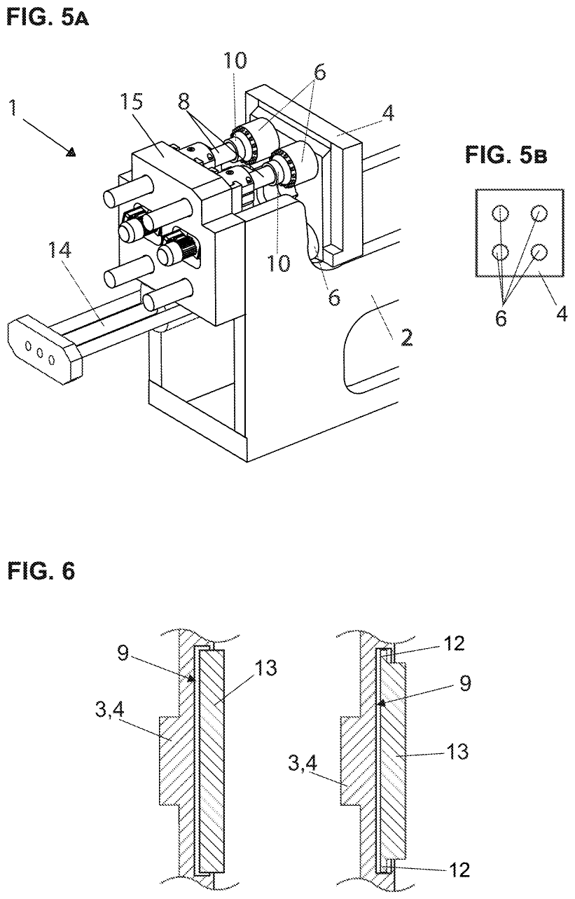

FIG. 5a shows a perspective partial view of a fourth embodiment of a clamping unit 1 according to the invention, which has four pressure pads 6 arranged symmetrically on the movable platen 4.

FIG. 5b shows a view, associated with this embodiment, of the arrangement of the pressure pads 6 on the movable platen 4. In contrast to all previous embodiments, this embodiment has no ejector support plate 7.

This embodiment has at least one fast stroke drive mechanism 14 for carrying out a fast stroke movement. The fast stroke drive mechanism 14 is preferably driven hydraulically using a fast stroke cylinder but can also be driven electromechanically by means of a spindle drive mechanism.

In this embodiment the force transmission unit 8 substantially consists of compression rods. However, other force transmission elements are also conceivable.

The fast stroke drive mechanisms 14 are beneficially different from the hydraulic cylinders of the pressure pads 6.

This embodiment has a support plate 15 at least on the drive-side end of the machine frame 2, on which the drive mechanisms, in particular the fast stroke drive mechanisms 14 and/or the pressure pads 6, can be supported.

The clamping unit 1 particularly preferably has a control or regulation unit for controlling or regulating the clamping unit 1, but this is not represented in the figures.

If there is more than one pressure pad 6, such as is the case e.g. in the embodiment of FIG. 5, the control or regulation unit is preferably formed to control or to regulate the pressure pads 6 depending on each other, and preferably also independently of each other.

FIG. 6 shows sections of two embodiments of a fluid mounting of platens or mould platens 13, wherein at least one mould platen 13 is mounted in a fluid bed 9 within the fixed platen 3 and/or the movable platen 4 in each case.

The fluid bed 9 can be viewed as a replacement for at least one pressure pad 6.

It may be noted that the mould, not represented, is located on the right-hand side in each case in these sections.

The movement of the fixed platen 3 and/or the movable platen 4 and/or the mould platen 13, preferably including the mould, is particularly preferably guided, with the result that an involuntary and/or unwanted tilting cannot take place.

In the right-hand embodiment, the mould platen 13 beneficially has a protrusion 12 along its edge, such that the fixed platen 3 or the movable platen 4 and the mould platen 13 together have the function of an in particular double-acting hydraulic cylinder.

However, it is also possible that the movement of the fixed platen 3 and/or the movable platen 4 and/or the at least one mould platen 13 is guided in another way, for example by means of at least one guide rod and/or a guide.

It can also be the case that the movement of the mould itself is guided.

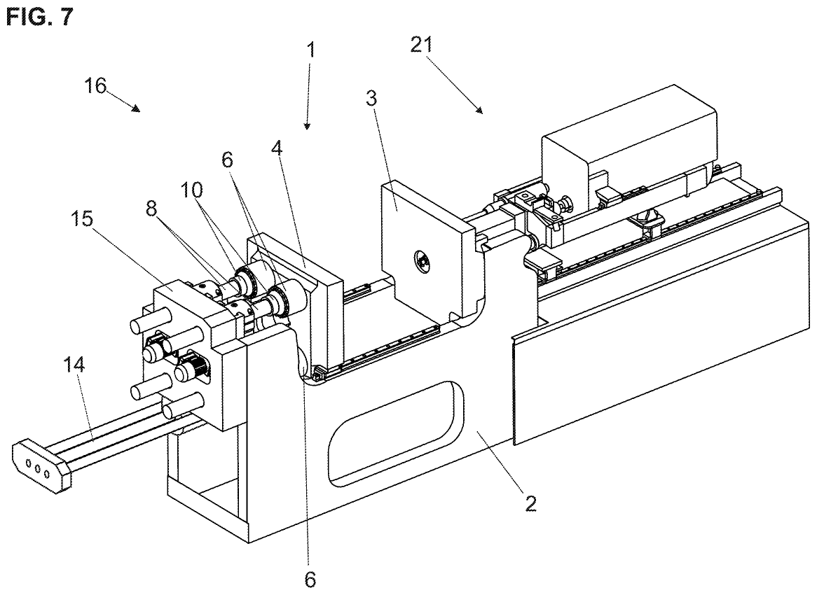

FIG. 7 shows a moulding machine 16 with the fourth embodiment of a clamping unit 1, already shown in FIG. 5, which has four pressure pads 6 arranged symmetrically on the movable platen 4.

The fixed platen 3 of the clamping unit 1 is also shown in this figure.

An injection unit 21 of the moulding machine 16 is also represented.

The clamping unit 1 and/or moulding machine 16 particularly preferably has at least one measuring unit for capturing data, wherein the measuring unit is not represented in the figures, however.

The measuring unit is preferably formed at least to capture data relating to the application of the clamping force and/or the parallelism of the fixed platen 3 and the movable platen 4.

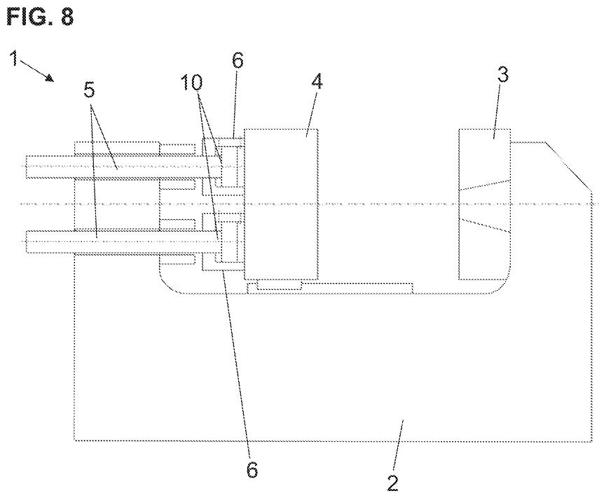

FIG. 8 shows a longitudinal section of a fifth embodiment of a clamping unit 1 according to the invention, wherein the clamping unit 1 does not comprise an ejector support plate 7 and wherein exactly two pressure pads 6 are positioned at and act directly on the movable platen 4.

The control unit or regulation unit is preferably designed to control or regulate the two pressure pads 6 in dependence of each other, and/or preferably also independently of each other.

In particular, the upper pressure pad 6, which is positioned further away from the machine frame 2, can be controlled or regulated such that it exerts higher forces on the movable platen 4 compared to the forces exerted by the lower pressure pad 6, which is positioned closer to the machine frame 2.

### LIST OF REFERENCE NUMBERS

1 clamping unit according to the invention
2 machine frame
3 fixed platen
4 movable platen
5 push rod
6 pressure pad
7 ejector support plate
8 force transmission unit
9 fluid bed
10 piston rod
11 piston head
12 protrusion
13 mould platen
14 fast stroke drive mechanism
15 support plate
16 moulding machine
17 ejector device
18 ejector bolt
19 ejector plates
20 ejector
21 injection unit

1. A tie-bar-less clamping unit for a moulding machine, comprising:
a machine frame, which is formed for absorbing clamping forces, and
a fixed platen arranged stationary in relation to the machine frame, and
a movable platen that can move relative to the machine frame, and
at least one push rod, preferably arranged substantially centrally with respect to the movable platen,
wherein at least one pressure pad is arranged between the push rod and the movable platen.

2. The clamping unit according to claim 1, wherein a movable ejector support plate that can move is arranged between the at least one push rod and the movable platen.

3. The clamping unit according to claim 2, wherein at least one pressure pad is arranged between the at least one push rod and the ejector support plate.

4. The clamping unit according to claim 2, wherein at least one pressure pad is arranged between the ejector support plate and the movable platen.

5. The clamping unit according to claim 1, wherein at least one force transmission unit is arranged between the at least one push rod and the movable platen.

6. The clamping unit according to claim 5, wherein the force transmission unit comprises at least one piston rod and/or one rod and/or one flexure hinge.

7. The clamping unit according to claim 1, wherein at least one mould platen is mounted in a fluid bed within the fixed platen and/or the movable platen.

8. The clamping unit according to claim 7, wherein, if the mould platen is mounted in a fluid bed, the movement of the fixed platen and/or the movable platen and/or the mould platen is guided.

9. The clamping unit according to claim 7, wherein the fluid bed and the fixed platen and/or the movable platen and/or the at least one mould platen are designed, in particular by a protrusion on the mould platen, such that together they have the function of an in particular double-acting hydraulic cylinder.

10. The clamping unit according to claim 1, wherein the clamping unit has at least one, preferably hydraulically and/or electromechanically driven, fast stroke drive mechanism for carrying out a fast stroke movement.

11. The clamping unit according to claim 1, wherein the clamping unit comprises a measuring unit for capturing data, wherein the measuring unit is designed at least to capture data relating to the application of the clamping force and/or the parallelism of the fixed platen and the movable platen.

12. The clamping unit according to claim 1, wherein the clamping unit comprises a control or regulation unit for controlling or regulating the clamping unit, in particular on the basis of data relating to the application of the clamping force and/or the parallelism of the fixed platen and the movable platen.

13. The clamping unit according to claim 12, wherein the at least one pressure pad is a first pressure pad of at least two pressure pads, and the control or regulation unit is formed to control or to regulate the first and a second of the at least two pressure pads depending on each other, and/or preferably also independently of each other.

14. A moulding machine, in particular comprising a substantially C-shaped machine frame, with the clamping unit according to claim 1.
